(19) United States
(12) Patent Application Publication
(10) Pub. No.: US 2024/0067534 A1
(43) Pub. Date: Feb. 29, 2024

(54) Cathode material and preparation method thereof, cathode plate and O3-type layered sodium ion battery

(71) Applicant: JIANGSU ZENERGY BATTERY TECHNOLOGIES CO., LTD., Jiangsu (CN)

(72) Inventors: Di WANG, Jiangsu (CN); Yingnan DONG, Jiangsu (CN); Qi YANG, Jiangsu (CN); Xiangxiang WANG, Jiangsu (CN); Jizong ZHANG, Jiangsu (CN); Fengkai DONG, Jiangsu (CN); Yimeng CHEN, Jiangsu (CN)

(21) Appl. No.: 18/237,367

(22) Filed: Aug. 23, 2023

(30) Foreign Application Priority Data
Aug. 25, 2022 (CN) 202211022666.8

(51) Int. Cl. C01G 53/00; H01M 10/054

(52) U.S. Cl. CPC C01G 53/50; H01M 10/054; C01P 2004/03; C01P 2006/40

(57) ABSTRACT

The disclosure relates to the technical field of batteries, and discloses a cathode material and a preparation method thereof, a cathode plate and an O3-type layered sodium ion battery. The chemical formula of the cathode material is NaM_{1-x-y-z}NiₓFe_{y}Mn_{z}O₂, wherein M comprises a first metal element, and the first metal element has at least one f electron orbital. Ni, Fe and Mn elements in the cathode material are elements containing a d electron orbital. By doping the element M, on the one hand, the f electron orbital and the d electron orbitals are mutually entangled, properties of the cathode material are synergistically improved, so that the structure and air stability of the material are improved; and on the other hand, interaction of all elements in the material can be facilitated, so that ions can move away from original positions to generate vacancies, ion diffusion channels of sodium ions are enlarged, and the rate capability of the material is improved. In addition, a redox reaction of oxygen atoms in anions in charging and discharging processes of the material can be excited, and thus the energy density and the power density of the material are improved.

### TECHNICAL FIELD

The present disclosure relates to the technical field of batteries, and in particular, to a cathode material, a preparation method thereof, a cathode plate, and an O3-type layered sodium ion battery.

### BACKGROUND

Lithium ion batteries are widely used in the field of energy devices. However, existing lithium element on the earth is very limited, which raises a general question of whether future lithium resources can satisfy the requirements. One method for solving this problem is to develop an energy storage device based on other carriers, and sodium ion batteries are expected to solve the requirements of energy storage in the future due to the advantages of abundant sodium resources and low costs and physical and chemical properties similar to those of lithium ion batteries. However, as the relative molecular mass of sodium is higher than that of lithium, and the radius of a sodium ion is also larger than that of a lithium ion, the energy density of sodium ion batteries is lower than that of lithium ion batteries, which greatly hinders the commercialized development of the sodium ion batteries. Therefore, development of a high-property electrode material is a problem that needs to be solved first for sodium ion batteries going to applications.

Among various cathode materials of sodium ion batteries, O3-NaNi_{0.5}Mn_{0.5}O₂ has received wide attention because it can provide sufficient sodium in the full battery, has high electrochemical activity and high theoretical specific capacity, and is easy to synthesize. However, it suffers from complex irreversible phase change and slow kinetic problem, resulting in quick fall in capacity and poor rate capability. In addition, another main problem limiting the application of O3-NaNi_{0.5}Mn_{0.5}O₂ is that it is particularly sensitive to air, and after exposure to air, its structure will be destroyed and electrochemical properties will be deteriorated.

To this end, in the prior art, doping a hetero element is usually used to improve the problems above. Wang et al. prepared an Al-doped NaAl_{0.2}Ni_{0.49}Mn_{0.49}O₂ material by means of a sol-gel method. When the current density is 240 mA·g⁻¹, the capacity retention of the 2 mol % Al-doped material after 200 cycles is 63.2%, which is 21.4% higher than that of NaNi_{0.5}Mn_{0.5}O₂. Although this method improves properties of the material, there is still a large difference from practical applications. Komaba et al. introduced Fe³⁺ into the NaNi_{0.5}Mn_{0.5}O₂ material, and obtained NaNi_{0.4}Mn_{0.4}Fe_{0.2}O₂. It undergoes a more reversible phase change in a high voltage region. In a voltage range of 2-3.8V, the capacity is 125 mA·h-1, and in a voltage range of 2.2-4.5V, the capacity at the first cycle is 185 mA·g-1. Although the tendency of the phase change is suppressed, it is still difficult to overcome the defect that the material is sensitive to air and water, so that the structure of the material fails.

In view of this, the present disclosure is particularly proposed.

### SUMMARY

An object of the present disclosure is to provide a cathode material having excellent electrochemical properties and stable properties, a preparation method thereof, and a cathode plate, which can effectively improve the electrochemical properties of an O3-type layered sodium ion battery.

Another object of the present disclosure is to provide an O3-type layered sodium ion battery, which comprises the described cathode material. Therefore, it also has the advantage of higher electrochemical properties.

The examples of the present disclosure are implemented as follows.

In a first aspect, the present disclosure provides a cathode material for an O3-type layered sodium ion battery, and the chemical formula of the cathode material is NaM_{1-x-y-z}NiₓFe_{y}Mn_{z}O₂, wherein x, y, and z are all positive numbers less than 1;
wherein M comprises a first metal element having at least one f electron orbital.

In an alternative embodiment, the first metal element comprises at least one of Pr, Nd, Sm, Eu, Tb, Dy, Ho, Er, Tm, and Yb.

In an alternative embodiment, the first metal element also has at least one d electron orbital.

In an alternative embodiment, the first metal element comprises at least one of Ce, Gd, and Lu; and x=0.01 or 0.1.

In an alternative embodiment, M further comprises a second metal element having at least one d electron orbital.

In an alternative embodiment, the second metal element comprises at least one of Ti, Cr, Mn, Zn, Ag, and Mo.

In an alternative embodiment, 0.01≤x≤1, 0.01≤y≤1, and 0.01≤z≤1.

In a second aspect, the present disclosure provides a method for preparing the cathode material according to any one of the foregoing embodiments, comprising:
uniformly mixing a cathode precursor salt, a sodium salt, and an M metal salt in a proportion to form a mixture, and sintering the mixture in a solid phase to obtain a cathode material.

In a third aspect, the present disclosure provides a cathode plate, comprising the cathode material of any one of the foregoing embodiments; or comprising a cathode material prepared by the method for preparing a cathode material according to the foregoing embodiments.

In a fourth aspect, the present disclosure provides an O3-type layered sodium ion battery, comprising the cathode plate of the foregoing embodiments.

The examples of the present disclosure have at least the following beneficial effects.

An example of the present disclosure provides a cathode material and a preparation method therefor. The cathode material is used for an O3-type layered sodium ion battery. The chemical formula of the cathode material is NaM_{1-x-y-z}NiₓFe_{y}Mn_{z}O₂, wherein x, y, and z are all positive numbers less than 1; wherein M comprises a first metal element having at least one f electron orbital. Ni, Fe, and Mn elements in the cathode material are all elements containing at least one d electron orbital. Therefore, by doping the element M, on the one hand, the f electron orbital in M and the d electron orbital in Ni, Fe, and Mn are mutually entangled, properties of the cathode material are synergistically improved, so as to improve the structural stability of the material and to reduce the susceptibility of the material to air; and on the other hand, interaction of all elements in the material can be facilitated, so that ions can move away from original positions to generate vacancies. The generation of vacancy can increase the ion diffusion channel of sodium ions, so as to improve the rate capability of the material, and ensure the electrical performance of a battery. In addition, a redox reaction of oxygen atoms in anions in charging and discharging processes of the material can be excited, and thus the energy density and the power density of the material are effectively improved.

An example of the present disclosure also provides a cathode plate and an O3-type layered sodium ion battery, comprising the described cathode material. Therefore, the cathode plate and the O3-type layered sodium ion battery also have the advantage of higher electrochemical properties.

### BRIEF DESCRIPTION OF THE DRAWINGS

To describe the technical solutions in the examples of the present disclosure more clearly, the following briefly introduces the accompanying drawings required for describing the examples. It is to be understood that the following drawings illustrate only certain examples of the disclosure and are therefore not to be considered limiting of its scope. For a person of ordinary skill in the art, other related drawings may also be obtained according to these drawings without creative efforts.

FIG. 1 is a structural diagram of a crystal of Na₂MnO₄ provided in the present disclosure;

FIG. 2 is a crystal structure of NaNi_{0.5}Mn_{0.5}O₂ provided by the present disclosure;

FIG. 3 is a scanning electron microscope photograph of a cathode material provided by example 1 of the present disclosure; and

FIG. 4 is a charging and discharging characteristic curve of the first cycle of a battery provided in example 1 of the present disclosure.

### DETAILED DESCRIPTION OF THE EMBODIMENTS

To make the objectives, technical solutions, and advantages of the examples of the present disclosure clearer, the following clearly and completely describes the technical solutions in the examples of the present disclosure. No specific conditions are noted in the examples, and the examples are either carried out as regular conditions or as suggested by the manufacturer. The reagents or instruments used are not noted by the manufacturer, and are conventional products that can be purchased commercially.

The features and properties of the present disclosure will be further described in detail below with reference to the examples.

On the basis of the fact that the effects of improving electrochemical properties of sodium ion batteries by doping elements in the prior art are limited, the examples of the present disclosure provide a cathode material having excellent electrochemical properties and stable properties, a preparation method thereof, and a cathode plate, which can effectively improve electrochemical properties of an O3-type layered sodium ion battery.

In an embodiment of the present disclosure, the cathode material is provided for an O3-type layered sodium ion battery, and of course, may also be used for other batteries as conditions allow. Moreover, the chemical formula of the cathode material is NaM_{1-x-y-z}NiₓFe_{y}Mn_{z}O₂, wherein x, y, and z are all positive numbers less than 1; and wherein M comprises a first metal element having at least one f electron orbital.

In the described cathode material, the Ni, Fe and Mn elements in the material are all elements containing one d electron orbital. Therefore, by doping the element M, on the one hand, the f electron orbital in M and the d electron orbital in Ni, Fe, and Mn are mutually entangled, properties of the cathode material are synergistically improved, so as to improve the structural stability of the material and to reduce the susceptibility of the material to air; and on the other hand, interaction of all elements in the material can be facilitated, so that ions can move away from original positions to generate vacancies. The generation of vacancy can increase the ion diffusion channel of sodium ions, so as to improve the rate capability of the material, and ensure the electrical performance of a battery. In addition, a redox reaction of oxygen atoms in anions in charging and discharging processes of the material can be excited, and thus the energy density and the power density of the material are effectively improved.

It should be noted that, in an embodiment, 0.01≤x≤1, 0.01≤y≤1, and 0.01≤z≤1; and preferably, 0.2≤x≤0.4, 0.2≤y≤0.4, and 0.2≤z≤0.4. By controlling the ratio of elements, the effect of the entanglement interaction between the d electron orbital and the f electron orbital can be maximized, so as to fully guarantee the electrochemical properties of the battery.

It should also be noted that the first metal element containing at least one f electron orbital may be selected as at least one of Pr, Nd, Sm, Eu, Tb, Dy, Ho, Er, Tm and Yb. Such first metal element only contains at least one f electron orbital and does not contain a d electron orbital, and can mutually entangle with d electron orbitals of Ni, Fe and Mn elements, so as to improve the stability of the material and the electrochemical properties of the material, thereby sufficiently improving the electrochemical properties of the battery.

Exemplarily, in an embodiment of the present disclosure, the first metal element may be specifically selected as Yb or Tb. Yb or Tb element belongs to a rare metal element, has an f electron orbital capable of entangling d electron orbitals, and can sufficiently improve the electrochemical properties and stability of a material by entanglement of electron orbitals. In addition, when the first metal element is specifically selected as Yb, x can be correspondingly selected as 0.2 or 0.5; and when the first metal element is selected as Tb, x can be correspondingly selected as 0.2. When a specific metal element is selected, the ratio of elements is controlled, so that the entanglement of the electron orbitals enables the components of the cathode material to cooperate with each other to generate vacancies, so as to enlarge the ion diffusion channel of sodium ions, thereby sufficiently improving the rate capability of the material and improving the electrochemical properties of the battery.

Of course, in the present embodiment, the first metal element may also have at least one d electron orbital. By introducing the d electron orbital again, the d-electron orbitals can be supplemented, so that the d electron orbitals can be sufficiently entangled with the f-electron orbital to sufficiently interact with each other, thereby effectively improving the electrochemical properties and stability of the material. Exemplarily, when the first metal element includes both a d electron orbital and an f electron orbital, the first metal element comprises at least one of Ce, Gd and Lu, and x=0.01 or 0.1. When a specific metal element is selected, the ratio of elements is controlled, so that the entanglement of the electron orbitals not only improves the stability of the material, but also enables the components of the cathode material to cooperate with each other to generate vacancies, so as to increase the ion diffusion channel of sodium ions, thereby sufficiently improving the rate capability of the material and improving the electrochemical properties of the battery.

As an alternative, in an embodiment of the present disclosure, M further comprises a second metal element having at least one d electron orbital. The addition of the second metal element may further supplement d electron orbitals, so as to better cooperate with the f electron orbital, thereby improving the electrochemical properties and stability of the material. Exemplarily, the second metal element comprises at least one of Ti, Cr, Mn, Zn, Ag, and Mo. The second metal element differs from the first metal element in that the first metal element must have at least one f electron orbital, and preferably also has at least one d electron orbital, while the second metal element, compared with the first metal element, only has a d electron orbital, and is used for supplementing or adapting the first metal element, so as to fully ensure the electrochemical properties of the battery.

An example of the present disclosure also provides a preparation method for the described cathode material, comprising evenly mixing a cathode precursor salt, a sodium salt, and an M metal salt in a proportion to form a mixture, and performing solid-phase sintering to obtain the cathode material.

In detail, the cathode precursor salt includes a nickel salt, a manganese salt, and an iron salt. Exemplarily, a corresponding material is selected from nickel oxide, nickel iron oxide, nickel iron manganese oxide, manganese oxide, iron oxide, manganese iron oxide, nickel manganese oxide, nickel hydroxide, iron hydroxide, manganese hydroxide, nickel iron hydroxide, nickel iron manganese hydroxide, and nickel manganese hydroxide. The sodium salt may be selected from sodium carbonate, sodium hydroxide, sodium oxide, sodium peroxide, sodium phosphate, sodium sulfate, sodium dihydrogen phosphate, sodium dihydrogen sulfate, sodium phenoxide and the like. The M metal salt can be selected according to a corresponding metal salt containing at least one f electron orbital and at least one d electron orbital. For example, it can be selected from materials such as cerium oxide, titanium oxide, samarium oxide, lutetium oxide, dysprosium oxide, and molybdenum oxide.

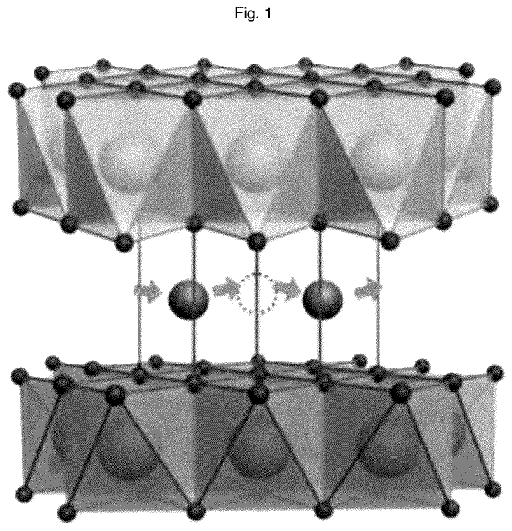

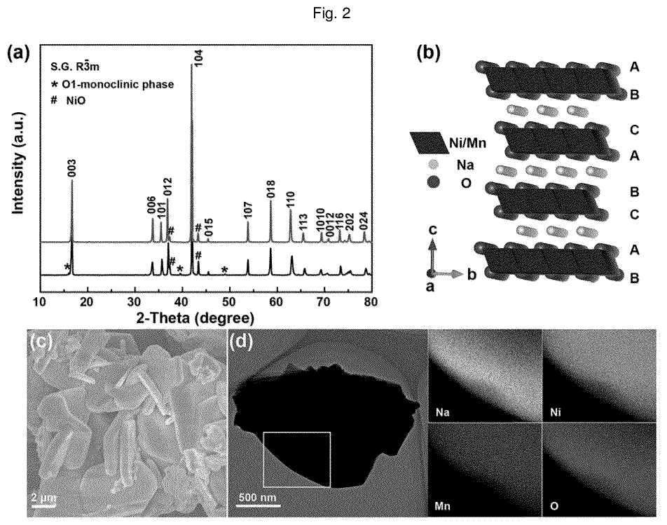

It should be noted that, FIG. 1 is a structural diagram of a crystal of Na₂MnO₄ according to the present disclosure, and FIG. 2 is a structural diagram of a crystal of NaNi_{0.5}Mn_{0.5}O₂ according to the present disclosure. In this example, the raw materials may be mixed by means of a low temperature sol gel method after direct contact, or may be mixed by means of high energy ball milling and stirring. The uniformly mixed mixture needs to be exposed to an oxidizing gas (the oxidizing gas may be oxygen or compressed air) or air, and then the mixture is subjected to a solid-state sintering treatment, wherein the heated temperature is 625° C. to 1210° C., and the holding time is 0.5-20 h. Furthermore, in the solid-phase sintering process, the material evolves based on a crystal structure of Na₂MnO₄ as shown in FIG. 1, and becomes a crystal structure of NaNi_{0.5}Mn_{0.5}O₂ as shown in FIG. 2, so as to obtain a material NaM_{1-x-y-z}NiₓFe_{y}Mn_{z}O₂.

Exemplarily, the cathode material may be selected from sodium carbonate, nickel iron manganese hydroxide, and terbium oxide, which are mixed in a molar ratio of a:b:c, wherein c is in the range of 0.01 to 1, and preferably 0.25 or 0.0375, a is 0.55 or 0.525, and b is substantially 1. By using the molar ratio, sufficient contact between the raw materials can be ensured, so as to ensure the preparation efficiency and quality of the material.

It should be noted that, in the examples of the present disclosure, the molecular formula of the cathode material is detected by ICP, and ICP-AES is referred to as Inductively Coupled Plasma-Atomic Emission Spectrometry, and also referred to as Inductively Coupled Plasma-Optical Emission Spectrometry (ICP-OES), which is not described in detail in the examples of the present disclosure.

An example of the present disclosure further provides a cathode plate, which is prepared by using the foregoing cathode material. The cathode plate can comprise a current collector and a cathode active material layer disposed on at least one side of the current collector. The cathode active material layer is obtained by coating a current collector with a cathode slurry, drying the cathode slurry, and cold pressing. The cathode slurry comprises a cathode material, a conductive agent, a binder, and a solvent. The current collector can be made of aluminium foil. The proportions of the conductive agent and the binder are respectively less than or equal to 5%. The conductive agent can be made of carbon black, carbon nanotubes, graphene, etc. The binder can be made of polyvinylidene fluoride (PVDF). The solvent can be made of N-methylpyrrolidone (NMP).

Specifically, when preparing the cathode plate, the prepared raw materials can be weighed first; the cathode material, the conductive carbon, and PVDF are mixed in a mass ratio of 90:5:5, then the mixture is dissolved in a certain amount of NMP, and stirred evenly. The solution is coated on the current collector, and dried. The resultant is cut to obtain the cathode plate.

The cathode plate comprises the foregoing cathode material. Therefore, the cathode plate also has the advantage of improving the electrochemical properties of the battery.

An example of the present disclosure further provides an O3-type layered sodium ion battery, comprising the cathode plate of the foregoing embodiment. Furthermore, the O3-type layered sodium ion battery specifically comprises housing, a cathode plate, a separator, an anode plate and an electrolyte. The cathode plate, the separator and the anode plate are arranged in a stacked manner, a bare cell is formed by means of laminating or winding, and a battery can be obtained after the bare cell is installed in the housing and the electrolyte is injected. The anode plate can comprise a current collector and an anode active material layer. The current collector may be selected as a copper foil. The anode active material layer is obtained by coating the current collector with an anode active slurry, and then drying and cold pressing. The anode active slurry comprises a anode material, a conductive agent, a binder, a dispersant and a solvent. The amounts of the conductive agent and the binder are both less than or equal to 10%. The anode material can be selected from soft carbon, hard carbon, composite carbon, etc. The conductive agent can be selected from conductive carbon black, conductive graphite, vapor phase grown carbon fibers, carbon nanotubes, etc. The binder can be selected from styrene-butadiene rubber. The dispersing agent can be selected from CMC. The solvent can be selected from N-methyl pyrrolidone (NMP). The electrolyte solution is obtained by dissolving 1 M sodium hexafluorophosphate in a solvent with a volume ratio of EC:PC=1:1.

Specifically, when preparing the anode plate, the prepared raw materials may be weighed first, and the anode hard carbon material, the conductive carbon, and CMC/SBR are mixed in a mass ratio is 80:10:10. Then, the mixture is dissolved in a certain amount of NMP, and stirred until uniform. The solution is coated on the current collector, and dried. The resultant is cut to obtain the anode plate.

The O3-type layered sodium ion battery comprises the foregoing cathode material. Therefore, the O3-type layered sodium ion battery also has the characteristic of excellent electrochemical properties.

The preparation process and properties of the battery will be described in detail below in conjunction with particular examples and comparative examples:

### Example 1

The present example provides an O3-type layered sodium ion battery, which is prepared by the following method.

S1: Preparation of a cathode plate. Step S1 specifically comprises the following steps.

S11: Preparation of a cathode material

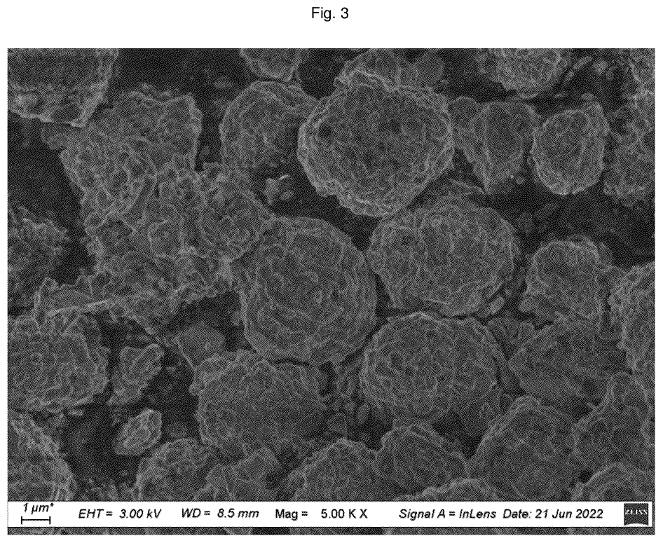

Step S11 specifically comprises: placing precursors of sodium carbonate, nickel iron manganese hydroxide and terbium oxide into a high energy ball mill tank according to a certain stoichiometric amount and placing same on a ball mill, ball milling at a rotation speed of 3000 rpm for 1.05 hours, heating in a vacuum oven and drying to prepare precursor particles, rapidly transferring the precursor particles into a high-temperature solid-phase sintering furnace, and using compressed air or oxygen protection at an appropriate ratio in the furnace, heating at a heating rate of 1-10° C./min, heating at 815° C. for 9.5 hours to obtain a NaTb_{0.2}Ni_{0.2}Fe_{0.3}Mn_{0.5}O₂ cathode material. An SEM micrograph of the prepared cathode material is as shown in FIG. 3.

S12: Preparation of an electrode plate

Step S12 specifically comprises: mixing the cathode material, conductive carbon SP and PVDF in a mass ratio of 90:5:5, then dissolving the mixture in a certain amount of NMP, stirring until uniform, coating the solution on both sides of a current collector, drying, and cutting to obtain a cathode plate.

S2: Preparation of an anode plate:

Step S2 specifically comprises mixing a hard carbon material, conductive carbon, and CMC/SBR with a mass ratio of 80:10:10, then dissolving the mixture in a certain amount of NMP, stirring until uniform, coating the solution on a current collector, drying, and cutting to obtain an anode plate.

S3 comprises: sequentially providing the cathode plate, a separator and the anode plate, winding to prepare a bare cell, then filling the bare cell into a housing, then injecting an electrolyte, letting the electrolyte-injected battery sit on, pre-charging, removing exhaust gas, sealing, and dividing the volume, so as to prepare an O3-type layered sodium ion battery. The O3-type layered sodium ion battery is a button battery, and the weight of the position electrode plate of a single battery is about 1 mg to 1.5 mg.

### Example 2

Example 2 provides an O3-type layered sodium ion battery. The preparation method is the same as that of example 1 except the following features.

Step S11 specifically comprises: contacting sodium carbonate, terbium oxide, nickel nitrate, ferrous oxalate, and manganese oxide to form a mixed powder; placing the mixed powder into a ball milling tank, and performing ball milling and stirring with an ethanol organic solvent at a rotating speed of 1400 rpm for 2.5 h to prepare a precursor material, and drying in a vacuum; rapidly transferring the resultant into a high-temperature solid-phase sintering furnace, and at the same time protecting same with compressed air or oxygen in the furnace; protecting and heating same at 925° C. for 12.5 h, then taking out materials and adding terbium oxide, continuing to ball milling the resultant for 0.5 h, and then transferring same into the furnace for secondary sintering, the temperature being about 885° C., the holding time being 10 h, so as to obtain a NaTb_{0.2}Ni_{0.2}Fe_{0.3}Mn_{0.5}O₂ cathode material.

### Example 3

Example 3 provides an O3-type layered sodium ion battery. The preparation method is the same as that of example 1 except the following features.

Step S11 specifically comprises: placing sodium carbonate, nickel iron manganese hydroxide and samarium oxide into a high energy ball milling tank according to a certain stoichiometric amount, and placing the mixture on a ball mill; ball milling at a rotation speed of 3000 rpm for 1.05 hours, and heating the resultant in a vacuum oven and drying same to prepare a precursor; rapidly transferring the precursor into a high-temperature solid-phase sintering furnace, and at the same time, using compressed air or oxygen for protection in a suitable proportion in the furnace, heating at a heating rate of 1-10° C./min, and heating at 815° C. for 9.5 hours, so as to obtain an NaSm_{0.2}Ni_{0.2}Fe_{0.3}Mn_{0.5}O₂ cathode material.

### Example 4

Example 4 provides an O3-type layered sodium ion battery. The preparation method is the same as that of example 1 except the following features.

Step S11 specifically comprises: placing sodium carbonate, nickel iron manganese hydroxide, samarium oxide and cerium oxide into a high energy ball milling tank according to a certain stoichiometric amount, and placing the mixture on a ball mill; ball milling at a rotation speed of 3000 rpm for 2 h, heating in a vacuum oven and drying to prepare a precursor; and rapidly transferring the precursor into a high-temperature solid-phase sintering furnace, and at the same time, using compressed air or oxygen under protection in a suitable proportion in the furnace, heating at a rate of 1-10° C./min, and heating at 820° C. for 10 h, so as to obtain a NaCe_{0.1}Sm_{0.1}Ni_{0.2}Fe_{0.3}Mn_{0.5}O₂ cathode material.

### Example 5

Example 5 provides an O3-type layered sodium ion battery. The preparation method is the same as that of example 1 except the following feature.

Step S11 specifically comprises: placing sodium carbonate, nickel iron manganese hydroxide, ytterbium oxide and cerium oxide into a high energy ball milling tank according to a certain stoichiometric amount, and placing the mixture on a ball mill; ball milling at a rotation speed of 3000 rpm for 2.1 h, heating in a vacuum oven and drying to prepare a precursor; and rapidly transferring the precursor into a high-temperature solid-phase sintering furnace, and at the same time, using compressed air or oxygen for protection in a suitable proportion in the furnace, heating at a rate of 1-10° C./min, and heating at 830° C. for 9 h, so as to obtain a NaCe_{0.1}Yb_{0.1}Ni_{0.2}Fe_{0.3}Mn_{0.5}O₂ cathode material.

### Example 6

Example 6 provides an O3-type layered sodium ion battery. The preparation method is the same as that of example 1 except the following features.

Step S11 specifically comprises: placing sodium carbonate, nickel iron manganese hydroxide, molybdenum oxide and samarium oxide into a high energy ball milling tank according to a certain stoichiometric amount, and placing the mixture on a ball mill; ball milling at a rotating speed of 3000 rpm for 1.9 hours, heating in a vacuum oven and drying to prepare a precursor; and quickly transferring the precursor into a high-temperature solid-phase sintering furnace, and at the same time, using compressed air or oxygen for protection in a suitable proportion in the furnace, heating a rate of 1-10° C./min, and heating at 850° C. for 8.5 hours, so as to obtain a NaSm_{0.1}Mo_{0.1}Ni_{0.2}Fe_{0.3}Mn_{0.5}O₂ cathode material.

### Example 7

Example 7 provides an O3-type layered sodium ion battery. The preparation method is the same as that of example 1 except the following features.

The cathode material prepared by the step S11 is NaTb_{0.1}Ni_{0.1}Fe_{0.3}Mn_{0.5}O₂.

### Example 8

Example 8 provides an O3-type layered sodium ion battery. The preparation method is the same as that of example 2 except the following features.

The cathode material prepared by the step S11 is NaTb_{0.1}Ni_{0.1}Fe_{0.3}Mn_{0.5}O₂.

### Example 9

Example 9 provides an O3-type layered sodium ion battery. The preparation method is the same as that of example 2 except the following features.

The cathode material prepared by the step S11 is NaSm_{0.2}Ni_{0.2}Fe_{0.3}Mn_{0.3}O₂.

### Comparative Example 1

Comparative example 1 provides an O3-type layered sodium ion battery. The preparation method is the same as that of example 1 except the following features.

The cathode material prepared by the step S11 is NaNi_{0.4}Fe_{0.3}Mn_{0.3}O₂.

### Comparative Example 2

Comparative example 2 provides an O3-type layered sodium ion battery. The preparation method is the same as that of example 2 except the following features.

The cathode material prepared by the step S11 is NaNi_{0.4}Fe_{0.3}Mn_{0.3}O₂.

### Experimental Example 1

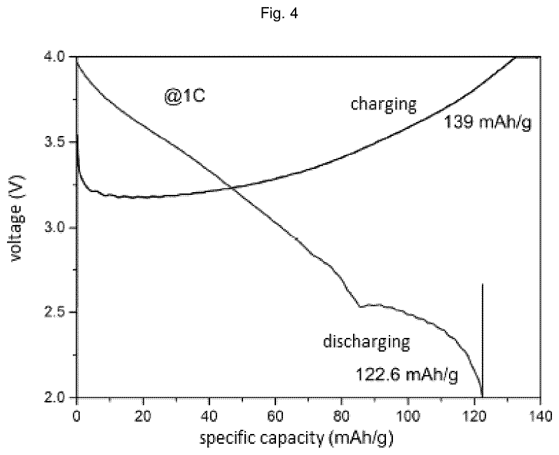

The O3-type layered sodium ion batteries provided in examples 1-9 and comparative examples 1 and 2 are subjected to a discharge specific capacity test at a current density of 1C, wherein the test conditions are first charging and then discharging, charging is performed under a constant current, and the current is 1C, which is a correspondingly calculated current. (For example, the design capacity is 1 Ah, the 1C current density is 1 mA/g, the current is calculated by combining the cell mass and the loading capacity of the cathode plate and is input into the system, and the voltage range is 2-4V).) The test results are shown in FIG. 1 and FIG. 4. FIG. 4 is a result diagram of example 1. In table 1, method 1 refers to the preparation method of example 1, and method 2 refers to the preparation method of example 2.

TABLE 1
Discharge specific capacity test results

| | | Discharge |
|---|---|---|
| | | specific |
| | | capacity at a |
| | | current density |
| Item | Chemical formula/synthesis method | of 1 C |
| Example 1 | NaTb_{0.2}Ni_{0.2}Fe_{0.3}Mn_{0.3}O₂/method 1 | 122.6 |
| Example 2 | NaTb_{0.2}Ni_{0.2}Fe_{0.3}Mn_{0.3}O₂/method 2 | 117.4 |
| Example 3 | NaSm_{0.2}Ni_{0.2}Fe_{0.3}Mn_{0.3}O₂/method 1 | 110.5 |
| Example 4 | NaCe_{0.1}Sm_{0.1}Ni_{0.2}Fe_{0.3}Mn_{0.3}O₂/method 1 | 109.8 |
| Example 5 | NaCe_{0.1}Yb_{0.1}Ni_{0.2}Fe_{0.3}Mn_{0.3}O₂/method 1 | 112.5 |
| Example 6 | NaSm_{0.1}Mo_{0.1}Ni_{0.2}Fe_{0.3}Mn_{0.3}O₂/method 1 | 113.4 |
| Example 7 | NaTb_{0.1}Ni_{0.1}Fe_{0.3}Mn_{0.5}O₂/method 1 | 118.4 |
| Example 8 | NaTb_{0.1}Ni_{0.1}Fe_{0.3}Mn_{0.5}O₂/method 2 | 115.6 |
| Example 9 | NaSm_{0.2}Ni_{0.2}Fe_{0.3}Mn_{0.3}O₂/method 2 | 103.2 |
| Comparative | NaNi_{0.4}Fe_{0.3}Mn_{0.3}O₂/method 1 | 95.2 |
| example 1 | | |
| Comparative | NaNi_{0.4}Fe_{0.3}Mn_{0.3}O₂/method 2 | 99.5 |
| example 2 | | |

It can be determined from the comparison between examples 1-9 and comparative examples 1 and 2 in table 1 and the data in FIGS. 1 and 2 that the examples of the present disclosure can prepare a cathode material in the shape of a sphere by doping a metal element having an f electron orbital, and can effectively improve the discharge specific capacity of a battery. It can be determined from comparison between data in examples 1 and 3-6 and those in examples 2, 8 and 9 that, by using the method for preparing a cathode material provided in example 1, the discharge specific capacity of the battery can be better improved, and the electrochemical properties of the battery can be guaranteed, and the electrochemical properties of the battery can also be improved to some extent by using the method for preparing a cathode material provided in example 2, but the improvement is smaller than that of the method used in example 1. According to comparison the data of examples 1 and 2-6 and those of example 7, it can be determined that when 0.2≤x≤0.4, 0.2≤y≤0.4, and 0.2≤z≤0.4 are all controlled within corresponding ranges, the discharge specific capacity of the battery can be better improved, and the electrochemical properties of the battery can be guaranteed.

### Experimental Example 2

The O3-type layered sodium ion batteries provided in examples 1-9 and comparative examples 1 and 2 are subjected to a Coulombic efficiency test, wherein the test conditions are first charging and then discharging, charging is performed with a constant current, and the current is 1C, which is a correspondingly calculated current. (For example, the design capacity is 1 Ah, the 1C current density is 1 mA/g, the current is calculated by combining the cell mass and the loading capacity of the cathode plate and is input into the system, and the voltage range is 2-4 V).) The test results are shown in table 2. In table 2, method 1 refers to the preparation method of example 1, and method 2 refers to the preparation method of example 2.

TABLE 2
Test results of first coulombic efficiency

| | | First coulombic |
|---|---|---|
| Item | Chemical formula/synthesis method | efficiency % |
| Example 1 | NaTb_{0.2}Ni_{0.2}Fe_{0.3}Mn_{0.3}O₂/method 1 | 88.2 |
| Example 2 | NaTb_{0.2}Ni_{0.2}Fe_{0.3}Mn_{0.3}O₂/method 2 | 87.8 |
| Example 3 | NaSm_{0.2}Ni_{0.2}Fe_{0.3}Mn_{0.3}O₂/method 1 | 80.57 |
| Example 4 | NaCe_{0.1}Sm_{0.1}Ni_{0.2}Fe_{0.3}Mn_{0.3}O₂/method 1 | 85.6 |
| Example 5 | NaCe_{0.1}Yb_{0.1}Ni_{0.2}Fe_{0.3}Mn_{0.3}O₂/method 1 | 86.7 |
| Example 6 | NaSm_{0.1}Mo_{0.1}Ni_{0.2}Fe_{0.3}Mn_{0.3}O₂/method 1 | 87.9 |
| Example 7 | NaTb_{0.1}Ni_{0.1}Fe_{0.3}Mn_{0.5}O₂/method 1 | 85.2 |
| Example 8 | NaTb_{0.1}Ni_{0.1}Fe_{0.3}Mn_{0.5}O₂/method 2 | 86.5 |
| Example 9 | NaSm_{0.2}Ni_{0.2}Fe_{0.3}Mn_{0.3}O₂/method 2 | 85.7 |
| Comparative | NaNi_{0.4}Fe_{0.3}Mn_{0.3}O₂/method 1 | 75.6 |
| example 1 | | |
| Comparative | NaNi_{0.4}Fe_{0.3}Mn_{0.3}O₂/method 2 | 79.56 |
| example 2 | | |

According to the data in table 2, it can be determined that, in the examples of the present disclosure, a cathode material in the shape of a sphere can be prepared by doping a metal element having at least one f electron orbital, and the first-time Coulombic efficiency of a battery can be effectively improved. By comparing the data in examples 1 and 3-6 and the data in examples 2 and 8-9, it can be determined that, by using the method for preparing a cathode material provided in example 1, the first Coulombic efficiency of the battery can be better improved, and the electrochemical properties of the battery can be guaranteed, and by using the method for preparing a cathode material provided in example 2, the electrochemical properties of the battery can also be improved to some extent, but the improvement strength is less than that of the method used in example 1. According to the data of examples 1 and 2-6 and the data of example 7, it can be determined that when 0.2≤x≤0.4, 0.2≤y≤0.4 and 0.2≤z≤0.4 are all controlled within corresponding ranges, the first Coulombic efficiency of the battery can be better improved, and the electrochemical properties of the battery can be guaranteed.

### Experimental Example 3

The O3-type layered sodium ion batteries provided in examples 1-9 and comparative examples 1 and 2 are respectively tested for the rate capability under a current density of 0.5/2/5C, wherein the test conditions are first charging and then discharging, charging is performed with a constant current, and the current is 1C, which is a correspondingly calculated current. (For example, the design capacity is 1 Ah, the 1C current density is 1 mA/g, the current is calculated by combining the cell mass and the loading capacity of the cathode plate and is input into the system, and the voltage range is 2-4V).) The test results are shown in Table 3. In table 3, method 1 refers to the preparation method of example 1, and method 2 refers to the preparation method of example 2.

TABLE 3
Test Results of rate capability

| | | Rate capability0.5/2/5 C |
|---|---|---|
| Item | Chemical formula/synthesis method | (mA h/g) |
| Example 1 | NaTb_{0.2}Ni_{0.2}Fe_{0.3}Mn_{0.3}O₂/method 1 | 128.5/120.4/115.8 |
| Example 2 | NaTb_{0.2}Ni_{0.2}Fe_{0.3}Mn_{0.3}O₂/method 2 | 118.3/115.3/110.56 |
| Example 3 | NaSm_{0.2}Ni_{0.2}Fe_{0.3}Mn_{0.3}O₂/method 1 | 115.6/103.4/96.5 |
| Example 4 | NaCe_{0.1}Sm_{0.1}Ni_{0.2}Fe_{0.3}Mn_{0.3}O₂/method 1 | 116.7/109.8/100.4 |
| Example 5 | NaCe_{0.1}Yb_{0.1}Ni_{0.2}Fe_{0.3}Mn_{0.3}O₂/method 1 | 120.4/118.9/112.1 |
| Example 6 | NaSm_{0.1}Mo_{0.1}Ni_{0.2}Fe_{0.3}Mn_{0.3}O₂/method 1 | 119.5/110.2/106.5 |
| Example 7 | NaTb_{0.1}Ni_{0.1}Fe_{0.3}Mn_{0.5}O₂/method 1 | 120.5/113.1/104.6 |
| Example 8 | NaTb_{0.1}Ni_{0.1}Fe_{0.3}Mn_{0.5}O₂/method 2 | 110.8/105.6/93.1 |
| Example 9 | NaSm_{0.2}Ni_{0.2}Fe_{0.3}Mn_{0.3}O₂/method 2 | 115.4/108.1/97.2 |
| Comparative example 1 | NaNi_{0.4}Fe_{0.3}Mn_{0.3}O₂/method 1 | 100.2/92.8/83.4 |
| Comparative example 2 | NaNi_{0.4}Fe_{0.3}Mn_{0.3}O₂/method 2 | 104.6/93.8/85.6 |

According to the data in table 3, it can be determined that the examples of the present disclosure can prepare a cathode material in the form of a sphere by doping a metal element having an f electron orbital, and can effectively improve the rate capability of the battery. By comparing the data in examples 1 and 3-6 with those in examples 2, 8 and 9, it can be determined that, by using the method for preparing a cathode material provided in example 1, the rate capability of the battery can be better improved, and the electrochemical properties of the battery can be ensured, and by using the method for preparing a cathode material provided in example 2, the electrochemical properties of the battery can also be improved to some extent, but the improvement strength is smaller than that of the method used in example 1. According to the data of examples 1 and 2-6 and the data of 7, it can be determined that when 0.2≤x≤0.4, 0.2≤y≤0.4, and 0.2≤z≤0.4 are all controlled within the corresponding ranges, the rate capability of the battery can be better improved, and the electrochemical properties of the battery can be guaranteed.

### Experimental Example 4

The O3-type layered sodium ion batteries provided in examples 1-9 and comparative examples 1 and 2 are subjected to an air stability test at a current density of 0.5/2/5C, respectively. The test conditions are that the specific capacity is tested after being exposed to air for 30 days. The test results are shown in table 4. In table 4, method 1 refers to the preparation method of example 1, and method 2 refers to the preparation method of example 2.

TABLE 4
Test results of air stability

| | | air stability |
|---|---|---|
| | | (specific |
| | | capacity after |
| | | exposure for |
| | | 30 days) |
| Item | Chemical formula/synthesis method | (mA h/g) |
| Example 1 | NaTb_{0.2}Ni_{0.2}Fe_{0.3}Mn_{0.3}O₂/method 1 | 118.2 |
| Example 2 | NaTb_{0.2}Ni_{0.2}Fe_{0.3}Mn_{0.3}O₂/method 2 | 110.4 |
| Example 3 | NaSm_{0.2}Ni_{0.2}Fe_{0.3}Mn_{0.3}O₂/method 1 | 105.2 |
| Example 4 | NaCe_{0.1}Sm_{0.1}Ni_{0.2}Fe_{0.3}Mn_{0.3}O₂/method 1 | 103.7 |
| Example 5 | NaCe_{0.1}Yb_{0.1}Ni_{0.2}Fe_{0.3}Mn_{0.3}O₂/method 1 | 104.8 |
| Example 6 | NaSm_{0.1}Mo_{0.1}Ni_{0.2}Fe_{0.3}Mn_{0.3}O₂/method 1 | 102.1 |
| Example 7 | NaTb_{0.1}Ni_{0.1}Fe_{0.3}Mn_{0.5}O₂/method 1 | 100.4 |
| Example 8 | NaTb_{0.1}Ni_{0.1}Fe_{0.3}Mn_{0.5}O₂/method 2 | 102.5 |
| Example 9 | NaSm_{0.2}Ni_{0.2}Fe_{0.3}Mn_{0.3}O₂/method 2 | 102.8 |
| Comparative | NaNi_{0.4}Fe_{0.3}Mn_{0.3}O₂/method 1 | 83.2 |
| example 1 | | |
| Comparative | NaNi_{0.4}Fe_{0.3}Mn_{0.3}O₂/method 2 | 77.9 |
| example 2 | | |

According to the data in table 4, it can be determined that the examples of the present disclosure can prepare a cathode material in the shape of a sphere by doping a metal element having at least one f electron orbit, and the air stability of the battery can be effectively improved. By comparing the data in examples 1 and 3-6 with those in examples 2, 8 and 9, it can be determined that the air stability of the battery can be better improved by using the method for preparing a cathode material provided in example 1, and the electrochemical properties of the battery can be ensured, and the air stability of the battery can also be improved to some extent by using the method for preparing a cathode material provided in example 2, but the improvement strength is smaller than that of the method used in example 1. According to the data of examples 1 and 2-6 and the data of example 7, it can be determined that when 0.2≤x≤0.4, 0.2≤y≤0.4, and 0.2≤z≤0.4 are all controlled within the corresponding ranges, the air stability of the battery can be better improved, and the electrochemical properties of the battery can be guaranteed.

According to the data in tables 1 to 4, it can be determined that the Ni, Fe, and Mn elements in the cathode material provided in the examples of the present disclosure are all elements containing a d electron orbital. By doping the element M, on the one hand, the f electron orbital in the element M and the d electron orbitals in the elements Ni, Fe, and Mn are mutually entangled, properties of the cathode material are synergistically improved, so that the structure and air stability of the material are improved; and on the other hand, interaction of all elements in the material can be facilitated, so that ions can move away from original positions to generate vacancies, ion diffusion channels of sodium ions are enlarged, the rate capability of the material is improved, and the electrochemical properties of the battery can be guaranteed. In addition, a redox reaction of oxygen atoms in anions in charging and discharging processes of the material can be excited, and thus the energy density and the power density of the material are effectively improved

In conclusion, the examples of the present disclosure provide a cathode material with excellent electrochemical properties and stable properties, a preparation method therefor, and a cathode plate. The cathode material can effectively improve the electrochemical properties of an O3-type layered sodium ion battery. An example of the present disclosure also provides an O₃-type layered sodium ion battery, comprising the described cathode material. Therefore, it also has the advantage of higher electrochemical properties.

The above are only the preferred examples of the disclosure and are not intended to limit the disclosure, and for those skilled in the art, the disclosure may have various modifications and variations. Any modifications, equivalent replacements, improvements and the like made within the spirit and principle of the present disclosure shall belong to the protection scope of the present disclosure.

1. A cathode material for an O3-type layered sodium ion battery, wherein:
the cathode material has a chemical formula of NaM_{1-x-y-z}NiₓFe_{y}Mn_{z}O₂, wherein x, y, and z are positive numbers less than 1; and
wherein M comprises a first metal element having at least one f electron orbital.

2. The cathode material according to claim 1, wherein:
the first metal element comprises at least one of Pr, Nd, Sm, Eu, Tb, Dy, Ho, Er, Tm, or Yb.

3. The cathode material according to claim 1, wherein: the first metal element is Yb or Tb; when the first metal element is Yb, x=0.2 or 0.5; and when the first metal element is Tb, x=0.2.

4. The cathode material according to claim 1, wherein:
the first metal element further has at least one d electron orbital.

5. The cathode material according to claim 4, wherein:
the first metal element comprises at least one of Ce, Gd, or Lu, and x=0.01 or 0.1.

6. The cathode material according to any one of claim 1, wherein:
M further comprises a second metal element having at least one d electron orbital.

7. The cathode material according to any one of claim 2, wherein:
M further comprises a second metal element having at least one d electron orbital.

8. The cathode material according to any one of claim 3, wherein:
M further comprises a second metal element having at least one d electron orbital.

9. The cathode material according to any one of claim 4, wherein:
M further comprises a second metal element having at least one d electron orbital.

10. The cathode material according to any one of claim 5, wherein:
M further comprises a second metal element having at least one d electron orbital.

11. The cathode material according to claim 6, wherein:
the second metal element comprises at least one of Ti, Cr, Mn, Zn, Ag, or Mo.

12. The cathode material according to claim 7, wherein:
the second metal element comprises at least one of Ti, Cr, Mn, Zn, Ag, or Mo.

13. The cathode material according to claim 8, wherein:
the second metal element comprises at least one of Ti, Cr, Mn, Zn, Ag, or Mo.

14. The cathode material according to claim 9, wherein:
the second metal element comprises at least one of Ti, Cr, Mn, Zn, Ag, or Mo.

15. The cathode material according to claim 10, wherein:
the second metal element comprises at least one of Ti, Cr, Mn, Zn, Ag, or Mo.

16. The cathode material according to claim 1, wherein:
the cathode material has a chemical formula of NaTb_{0.2}Ni_{0.2}Fe_{0.3}Mn_{0.5}O₂, NaSm_{0.2}Ni_{0.2}Fe_{0.3}Mn_{0.5}O₂, NaCe_{0.1}Sm_{0.1}Ni_{0.2}Fe_{0.3}Mn_{0.5}O₂, NaCe_{0.1}Yb_{0.1}Ni_{0.2}Fe_{0.3}Mn_{0.5}O₂, NaSm_{0.1}Mo_{0.1}Ni_{0.2}Fe_{0.3}Mn_{0.5}O₂ or NaTb_{0.1}Ni_{0.1}Fe_{0.3}Mn_{0.5}O₂.

17. The cathode material according to any one of claim 1, wherein:
0.01≤x≤1, 0.01≤y≤1, and 0.01≤z≤1.

18. A method for preparing the cathode material according to claim 1, comprising:
uniformly mixing a salt of cathode precursor, a sodium salt and an M metal salt in a proportion to form a mixture, and sintering same in a solid phase to obtain the cathode material.

19. A cathode plate, comprising the cathode material according to claim 1.

20. An O3-type layered sodium ion battery, comprising the cathode plate according to claim 19.
